(19) United States
(12) Patent Application Publication
(10) Pub. No.: US 2021/0071693 A1
(43) Pub. Date: Mar. 11, 2021

(54) PIVOT STRUCTURE

(71) Applicants: Inventec (Pudong) Technology Corporation, Shanghai (CN); INVENTEC CORPORATION, TAIPEI CITY (TW)

(72) Inventor: Yuan-Chang YANG, TAIPEI CITY (TW)

(21) Appl. No.: 16/711,449

(22) Filed: Dec. 12, 2019

(30) Foreign Application Priority Data
Sep. 6, 2019 (CN) 201910841545.8

(51) Int. Cl. F16B 5/00; F16B 21/10; F16B 17/00

(52) U.S. Cl. CPC F16B 5/008; F16B 17/006; F16B 21/10

(57) ABSTRACT

A pivot structure includes a first pivot element, a second pivot element, and a fixing element. The first pivot element includes a through hole. The second pivot structure includes a pivoting portion. The pivoting portion is rotatably engaged with the through hole. The fixing element is coupled with the second pivot element. The fixing element includes a first retaining portion, and the first pivot element is retained between the second pivot element and the first retaining portion.

### CROSS-REFERENCE TO RELATED APPLICATION

This application claims priority to China Application Serial Number 201910841545.8, filed Sep. 6, 2019, which is herein incorporated by reference in its entirety.

### BACKGROUND

### Field of Invention

The present invention relates to a pivot structure.

### Description of Related Art

In a typical method, the screws are mostly used when a rotation element is fixed on a supporting frame. The screws are used as rotation axis such that the rotation element may rotate relative to the screws. However, loosening problem between the outer screw thread and the inner screw thread of the supporting frame may occur during the rotation process of the rotation element, and the locking ability may not work that may cause the rotation element been loosened.

Another method to fixing the rotation element on the supporting frame is by rivet method, and a rivet is used as a rotation axis such that the rotation element may rotate relative to the rivet. The rivet method may not have the loosening problem of the rotation element relative to the rivet. However, it is needed to reserve the space for a stamping head and a support block around the supporting frame and the rotation element which may limit the structure design of the supporting frame and the rotation element.

Therefore, how to provide a pivot structure that may solve the aforementioned problems becomes an important issue to be solved by those in the industry.

### SUMMARY

The invention provides a pivot structure which is not fixed by screw or rivet so as to prevent loosening, and it is not necessary to reserve the space for a stamping head and a support block.

According to an embodiment of the discourse, the pivot structure includes a first pivot element, a second pivot element, and a fixing element. The first pivot element includes a through hole. The second pivot structure is includes a pivoting portion. The pivoting portion is rotatably engaged with the through hole. The fixing element is coupled with the second pivot element. The fixing element includes a first retaining portion, and the first pivot element is retained between the second pivot element and the first retaining portion.

In an embodiment of the disclosure, the first pivot element surrounds the pivot portion of the second pivot element.

In an embodiment of the disclosure, the fixing element passes through the second pivot element.

In an embodiment of the disclosure, the first retaining portion of the fixing element is in contact with the pivot portion of the second pivot element.

In an embodiment of the disclosure, the fixing element further includes a second retaining portion, and the second pivot element is retained between the first retaining portion and the second retaining portion.

In an embodiment of the disclosure, the fixing element further includes a connecting portion connected with the first retaining portion and the second retaining portion, and the pivot portion of the second pivot element surrounds the connecting portion of the fixing element.

In an embodiment of the disclosure, the first pivot element is separated from the connecting portion by the second pivot element.

In an embodiment of the disclosure, the second pivot element further includes a body portion connected with the pivot portion, and a distance between a surface of the body portion of the second pivot element facing the first pivot element and the first retaining element is greater than a thickness of the portion of the first pivot element located between the first retaining portion and the second retaining portion.

In an embodiment of the disclosure, the second retaining portion is in contact with the body portion of the second pivot element.

In an embodiment of the disclosure, the first pivot element further includes a chamfer, and the chamfer is located at a side of the first pivot element facing the second pivot element, and the chamfer is connected with a side wall of the through hole.

Accordingly, the present invention may prevent the loosening problem between the screw (fixing element) and the rotation element (first pivot element) of the typical pivot method that used screw as the fixing element can be prevented. Furthermore, the present invention may also prevent from reserving the space for a stamping head and a support block during a typical riveting method that fixing the first pivot element and the second pivot element by using the rivet method. As such, the flexibility of designing the structures of the first pivot element and the second pivot element can be increased.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective view of the pivot structure according to an embodiment of the present invention;

FIG. 2 is another perspective view of the pivot structure in FIG. 1; and

FIG. 3 is a cross-section view taken along line 3-3 in FIG. 1.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

In addition, terms used in the specification and the claims generally have the usual meaning as each terms are used in the field, in the context of the disclosure and in the context of the particular content unless particularly specified. Some terms used to describe the disclosure are to be discussed below or elsewhere in the specification to provide additional guidance related to the description of the disclosure to specialists in the art.

Phrases “first,” “second,” etc., are solely used to separate the descriptions of elements or operations with same technical terms, not intended to be the meaning of order or to limit the invention.

Secondly, phrases “comprising,” “includes,” “provided,” and the like, used in the context are all open-ended terms, i.e. including but not limited to.

Further, in the context, “a” and “the” can be generally referred to one or more unless the context particularly requires. It will be further understood that phrases “comprising,” “includes,” “provided,” and the like, used in the context indicate the characterization, region, integer, step, operation, element and/or component it stated, but not exclude descriptions it stated or additional one or more other characterizations, regions, integers, steps, operations, elements, components and/or groups thereof.

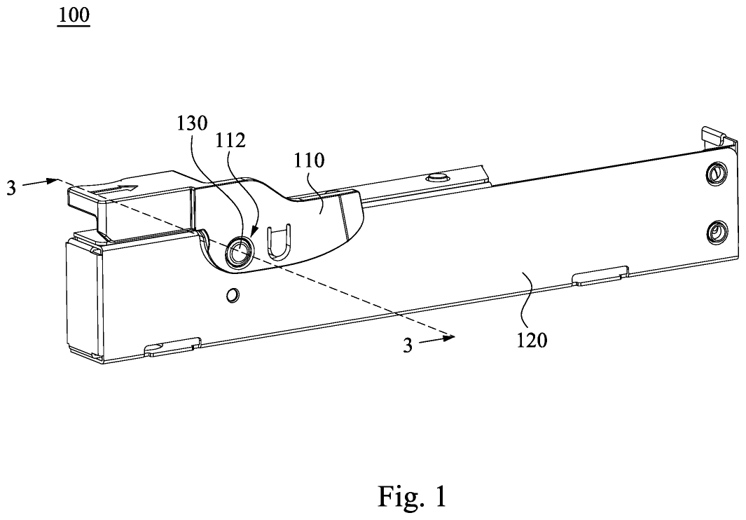

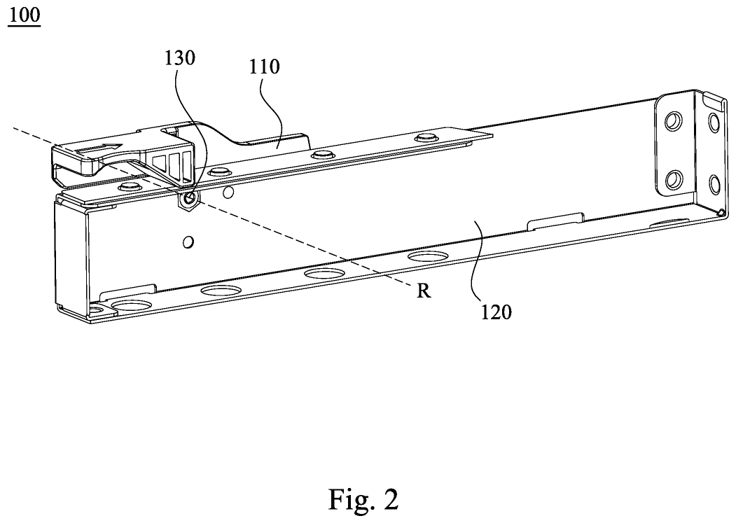

Reference is made to FIG. 1 and FIG. 2. FIG. 1 is a perspective view of the pivot structure 100 according to an embodiment of the present invention. FIG. 2 is another perspective view of the pivot structure 100 in FIG. 1. As shown in FIG. 1 and FIG. 2, the pivot structure 100 includes a first pivot element 110, a second pivot element 120, and a fixing element 130. The first pivot element 110 includes a through hole 112. The second pivot structure 120 is rotatably engaged with the through hole 112 of the first pivot element 110. The fixing element 130 is coupled with the second pivot element 120. The first pivot element 110 is retained between the second pivot element 120 and the fixing element 130.

In the present embodiment, the first pivot element 110 can be a fan supporting frame, but the present invention is not limited in this regard. The second pivot element 120 can be a rotation element, for example, a handle of the fan supporting frame, but the present invention is not limited in this regard. The second pivot element 120 may rotate relative to the first pivot element 110 along the rotation axis R. The fixing element 130 can be a rivet configured to retain the movement of the first pivot element 110 and the second pivot element 120 along a direction of the rotation axis R.

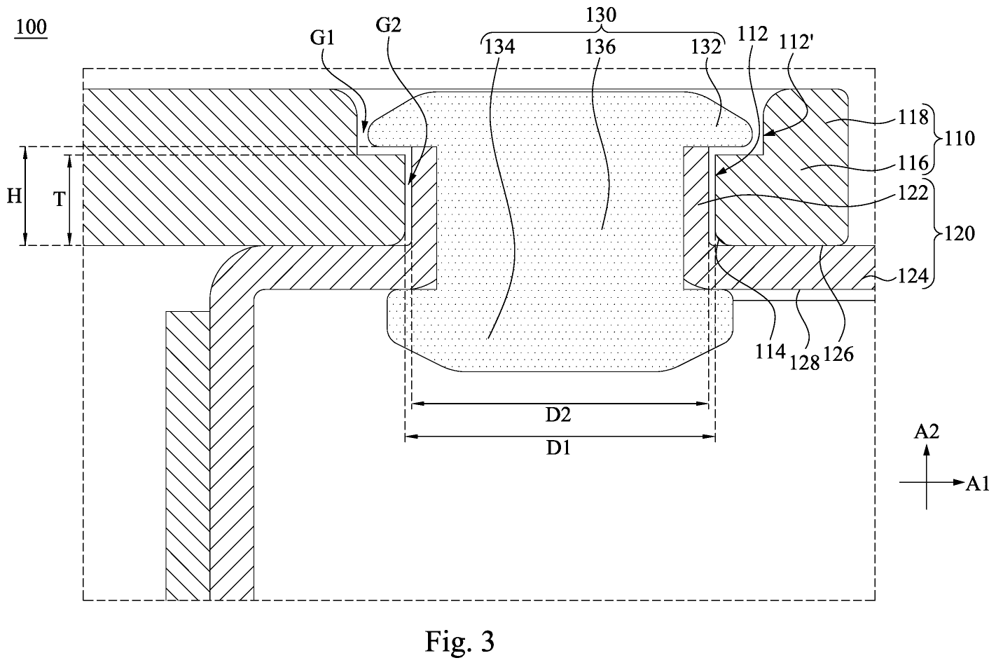

Reference is made to FIG. 3. FIG. 3 is a cross-section view taken along line 3-3 in FIG. 1. As shown in FIG. 3, the second pivot element 120 includes a pivot portion 122 and a body portion 124. In the cross-section view of FIG. 3, the pivot portion 122 is connected with the body portion 124, and the pivot portion 122 and the body portion 124 form a L-shaped bending region. In other words, the pivot portion 122 of the second pivot element 120 is a cylinder extending from the body portion 124, and the pivot portion 122 of the second pivot element 120 is bent and extends to the through hole 112 of the first pivot element 110. The first pivot element 110 surrounds the pivot portion 122 of the second pivot element 120. Therefore, the second pivot element 120 may retain the movement of the first pivot element 110 along the first axis A1. With such structure design, the fixing element 130 can merely provide the function to retain the first pivot element 110 and the second pivot element 120 along the second axis A2.

As shown in FIG. 3, in some embodiments, the fixing element 130 includes a first retaining portion 132, and the first pivot element 110 is retained between the body portion 124 of the second pivot element 120 and the first retaining portion 132 of the fixing element 130. In other words, the first pivot element 110 is configured to rotate relative to the pivot portion 122 of the second pivot element 120, but not directly pivoted to the fixing element 130. With such structure design, the loosening problem between the screw (fixing element) and the rotation element (first pivot element) of the typical pivot method that used screw as the fixing element can be prevented. In addition, in the embodiment a rivet is used as the fixing element 130, the need to reserving the space for a stamping head and a support block during a typical riveting method that fixing the first pivot element and the second pivot element by using the rivet method. As such, the flexibility of designing the structures of the first pivot element 110 and the second pivot element 120 can be increased.

In some embodiments, a material of the second pivot element 120 can be sheet metal, and the pivot portion 122 can be formed through piercing machining so as to be used as a rotation axis of the first pivot element 110. In some other embodiments, the material of the second pivot element 120 may be plastic, and it can be adjusted based on the practical condition.

As shown in FIG. 3, in the present embodiment, the fixing element 130 further includes a second retaining portion 134 and a connection portion 136. Two sides of the connection portion 136 are respectively connected with the first retaining portion 132 and the second retaining portion 134. The second pivot element 120 is retained between the first retaining portion 132 and the second retaining portion 134, and the pivot portion 122 of the second pivot element 120 surrounds the connection portion 136 of the fixing element 130. In other words, the fixing element 130 passes through the second pivot element 120. The connection portion 136 of the fixing element 130 is located in the through hole 112 of the first pivot element 110. The first retaining portion 132 and the second retaining portion 134 of the fixing element 130 are located outside the through hole 112. In some embodiments, the profiles of the first retaining portion 132 and the second retaining portion 134 are not limited as shown in FIG. 3, and it can be adjusted based on the practical condition.

As shown in FIG. 3, in the present embodiment, the body portion 124 includes a surface 126 and a surface 128 opposite to each other. The surface 126 faces the first pivot element 110, and the surface 128 is away from the first pivot element 110. The first retaining portion 132 of the fixing element 130 is in contact with the pivot portion 122 of the second pivot element 120, and the second retaining portion 134 of the fixing element 130 is in contact with the surface 128 of the body portion 124. In other words, the pivot portion 122 is fixed between the first retaining portion 132 and the second retaining portion 134 so as to retaining the second pivot element 120 between the first retaining portion 132 and the second retaining portion 134. In addition, the first pivot element 110 is separated from the connecting portion 136 of the fixing element 130 by the pivot portion 122 of the second pivot element 120. As such, the pivot portion 122 may damp the lateral force from the fixing element 130 during the mounting process. For example, in the embodiments that a rivet is used as a fixing element 130, the pivot portion 122 may buffer the impact force when the fixing element is deformed so as to reduce the damage to the first pivot element 110. In addition, the pivot portion 122 that is used as the rotation axis of the first pivot element 110 may partially support the fixing element 130 so as to reduce the lateral force suffered by the fixing element 130 when the first pivot element 110 rotates.

As shown in FIG. 3, in the present embodiment, the first pivot element 110 includes a first portion 116 and a second portion 118. The first portion 116 is partially located between the first retaining portion 132 and the second retaining portion 134 of the fixing element 130 so as to retain the first pivot element 110 between the first retaining portion 132 and the body portion 124 of the second pivot element 120. The second portion 118 protrudes form the first portion 116, and the first portion 116 surrounds the first retaining portion 132 of the fixing element 130. In other words, the second portion 118 further has a bigger through hole 112′ configured to receiving the first retaining element 132 of the fixing element 130, but the present invention is not limited in this regard. Specifically, as long as the first pivot element 110 has a portion located between the first retaining portion 132 of the fixing element 130 and the second retaining portion 134, the first retaining portion 132 and the second retaining portion 134 may retain the movement of the first pivot element 110 along the second axis A2. In the present embodiment, the volume of the through hole 112′ formed by the second portion 118 of the first pivot element 110 is greater than the first retaining portion 132 of the fixing element 130 so as to prevent from affecting the rotation fluency of the first pivot element 110.

As shown in FIG. 3, in the present embodiment, the surface of the first retaining portion 132 facing the first pivot element 110 and the second pivot element 120 is planar, and a distance H between the surface 126 of the body portion 124 of the second pivot element 120 facing the first pivot element 110 and the first retaining element 110 is greater than a thickness T of the first portion 116 of the first pivot element 110 located between the first retaining portion 132 and the second retaining portion 134. In other words, there is space for the first pivot element 110 to move along the second axis A2. Therefore, tightness of the rotation of the first pivot element 110 can be adjusted by controlling a difference between the distance H and the thickness T. For example, in some embodiments, the distance H is 0.15 mm greater than the thickness T. With such structure design, the first pivot element 110 will not move too much but will not be fixed tightly by the fixing element 130 and the second pivot element 120.

As shown in FIG. 3, in the present embodiment, the first pivot element 110 includes a chamfer 114. The chamfer 114 of the first pivot element 110 is located at a side of the first pivot element 110 facing the second pivot element 120, and the chamfer 114 is connected with a side wall of the through hole 112. In other words, the chamfer 114 of the first pivot element 110 is located at a bending region between the body portion 124 and the pivot portion 122 of the second pivot element 120. Such structure design may reduce the possibility of interference between the first pivot element 110 and the second pivot element 120 so as to prevent from affecting the rotation fluency of the first pivot element 110.

As shown in FIG. 3, in the present embodiment, a radius D1 of the through hole 112 of the first pivot element 110 is greater than an outer radius D2 of the pivot portion 122 of the second pivot element 120 so as to provide space for the first pivot element 110 to move along the first axis A1. Such structure design may reduce friction between the first pivot element 110 and the second pivot element 120 so as to prevent from affecting the rotation fluency of the first pivot element 110.

As shown in FIG. 3, in some embodiments, there is a gap G1 between the second portion 118 of the first pivot element 110 and the first retaining portion 132 of the fixing element 130. In addition, a difference between the radius D1 of the through hole 112 of the first pivot element 110 and the outer radius D1 of the pivot portion 122 form another gap G2, and the gap G2 is greater than the gap G1. When the pivot structure 100 is positioned at different orientation, even the first pivot element 110 is in contact with the pivot portion 122 of the second pivot element 120, the second portion 118 of the first pivot element 110 is not directly in contact with the first retaining portion 132 of the fixing element 130. As such, when the pivot structure 100 is positioned at different orientation, friction between the first pivot element 110 and the first retaining portion 132 of the fixing element 130 can be prevented so as to maintain the rotation fluency of the first pivot element 110 relative to the second pivot element 120.

In some embodiments, a height of the first pivot element 110 along the second axis A2 is higher than a height of the first retaining portion 132 of the fixing element 130. In other words, the through hole 112′ can be a counterbore, but the present invention is not limited in this regard, and it can be adjusted based on the practical conditions.

In some embodiments, the first retaining portion 132 and the retaining portion 134 second of the fixing element 130 are not simultaneously in contact with the pivot portion 122 and the surface 128 of the body portion 124 away from the first pivot element 110. In other words, in the present embodiment, there is space for the first pivot element 110 to move along the second axis A2. In the present embodiment, since the first pivot element 110 rotates when the second pivot element 120 is used as a rotation axis, it is merely required that the first pivot element 110 can be retained by the first retaining portion 132 of the fixing element 130 and the second pivot element 120.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A pivot structure, comprising:
a first pivot element having a through hole;
a second pivot element having a pivoting portion rotatably engaged with the through hole; and
a fixing element coupling with the second pivot element, wherein the fixing element comprises:
a first retaining portion, wherein the first pivot element is retained between the second pivot element and the first retaining portion.

2. The pivot structure of claim 1, wherein the first pivot element surrounds the pivot portion of the second pivot element.

3. The pivot structure of claim 1, wherein the fixing element passes through the second pivot element.

4. The pivot structure of claim 1, wherein the first retaining portion of the fixing element is in contact with the pivot portion of the second pivot element.

5. The pivot structure of claim 1, wherein the fixing element further comprises:
a second retaining portion, wherein the second pivot element is retained between the first retaining portion and the second retaining portion.

6. The pivot structure of claim 1, wherein the fixing element further comprises:
a connecting portion connected with the first retaining portion and the second retaining portion, and the pivot portion of the second pivot element surrounds the connecting portion of the fixing element.

7. The pivot structure of claim 1, wherein the first pivot element is separated from the connecting portion by the second pivot element.

8. The pivot structure of claim 1, wherein the second pivot element further comprises a body portion connected with the pivot portion, a distance between a surface of the body portion of the second pivot element facing the first pivot element and the first retaining element is greater than a thickness of the portion of the first pivot element located between the first retaining portion and the second retaining portion.

9. The pivot structure of claim 1, wherein the second retaining portion is in contact with the body portion of the second pivot element.

10. The pivot structure of claim 1, wherein the first pivot element further comprises a chamfer, wherein the chamfer is located at a side of the first pivot element facing the second pivot element, and the chamfer is connected with a side wall of the through hole.
